(19) United States
(12) Patent Application Publication
(10) Pub. No.: US 2008/0052167 A1
(43) Pub. Date: Feb. 28, 2008

(54) System and method for generating and distributing financial service fee

(76) Inventor: Mitchell Huhem, Cedar Hills, UT (US)

Correspondence Address: THE HECKER LAW GROUP, 1925 CENTURY PARK EAST, SUITE 2300, LOS ANGELES, CA, 90067, US

(21) Appl. No.: 11/897,252

(22) Filed: Aug. 28, 2007

Related U.S. Application Data
(60) Provisional application No. 60/840,980, filed on Aug. 28, 2006.

(51) Int. Cl. G06Q 30/00

(52) U.S. Cl. 705/14

(57) ABSTRACT

The present invention provides a method and system that allows a payment service provider to provide incentives to clients based not only on the level of use of the payment services by the clients themselves, but also based on efforts by clients to promote use by others of the payment service provider. Using the system of the present invention, the payment service provider benefits by acquiring new clients based on the recruitment efforts of its existing clients, and the existing clients benefit by being able to increase the level of benefits received beyond those attributed to the client's own spending.

### REFERENCE TO RELATED APPLICATION

This patent application claims the benefit of the filing date of U.S. Provisional Patent Application Ser. No. 60/840,980 entitled “System and Method for Generating and Distributing Financial Service Fees.”

### FIELD OF THE INVENTION

The invention relates to a method and system for generating and distributing fees for financial transactions and services, including transactions made using credit, debit, and similar payment cards and services.

A portion of the disclosure of this patent document contains material which is subject to copyright protection. The copyright owner has no objection to the facsimile reproduction by anyone of the patent document or the patent disclosure, as it appears in the Patent and Trademark Office file or records, but otherwise reserves all copyrights associated with this document.

### BACKGROUND

Financial transaction services providers such as American Express, Visa or Master Card provide payment facilities and services that facilitate cash payments between merchants and clients. Such payment service providers generate revenues by charging a transaction fee, typically to the merchants, on transactions made using the payment facility provided. The client (also sometimes referred to herein as a “user”) is typically the one who chooses which payment service provider is used for a particular transaction by using a payment card (e.g. a credit, debit, or smart card) issued by that provider. Thus, payment service providers are always looking for ways to increase the number and dollar amount of transactions made using their payment cards.

One approach used by payment service providers to acquire and keep clients is to offer incentives. For example, a payment service provider may offer insurance on goods purchased using a particular credit card, low interest rates on account balances or transferred balances, or reduced or waived late fees on bill payments. Another approach used by payment service providers to acquire and keep clients is to offer rewards such as cash bonuses in a form of a payment check, airline miles to be converted into travel airline tickets, or saving's coupons to be used in a given merchant's stores. Payment service providers may aggregate combinations of those incentives and rewards with a given payment card to acquire clients and promote greater use.

A limitation of prior art incentive systems is that the amount of incentives a client earns is dependent on and limited by the extent of that person's own use of the payment services. For example, in a typical airline mile incentive system, a client is awarded one airline mile for each dollar the client spends using an airline mile incentive payment card. Aside from using the card more (i.e. spending more dollars using the card) there is nothing else the client can do to increase the amount of incentives received. Further, once the client reaches his or her spending limit, the benefits to the payment service provider are capped as well.

### SUMMARY OF THE INVENTION

The present invention provides a method and system that allows a payment service provider to provide incentives to clients based not only on the level of use of the payment services by the clients themselves, but also based on efforts by clients to promote use by others of the payment service provider. Using the system of the present invention, the payment service provider benefits by acquiring new clients based on the recruitment efforts of its existing clients, and the existing clients benefit by being able to increase the level of benefits received beyond those attributed to the client's own spending.

### BRIEF DESCRIPTION OF THE DRAWINGS

FIG. 1 is an illustration of a hierarchical structure of a group of clients in an example embodiment of the invention.

### DETAILED DESCRIPTION OF THE INVENTION

The invention provides a method, system and a framework in which users of a payment service may receive rewards (e.g. cash) by participating in propagating information about that payment service and encouraging others to use that payment service. The payment service provider rewards the client based on the client's usage of the service and on the usage by other users whom the client referred to the service. In one or more embodiments, the incentive a client receives comprises a first percentage of the client's own usage of the payment service and a second percentage of the usage by other clients that have been recruited or referred by the first client.

In the following description, numerous specific details are set forth to provide a thorough description of the present invention. It will be apparent, however, to one skilled in the art, that the invention may be practiced without these specific details. In other instances, well known features have not been described in detail so as not to obscure the invention.

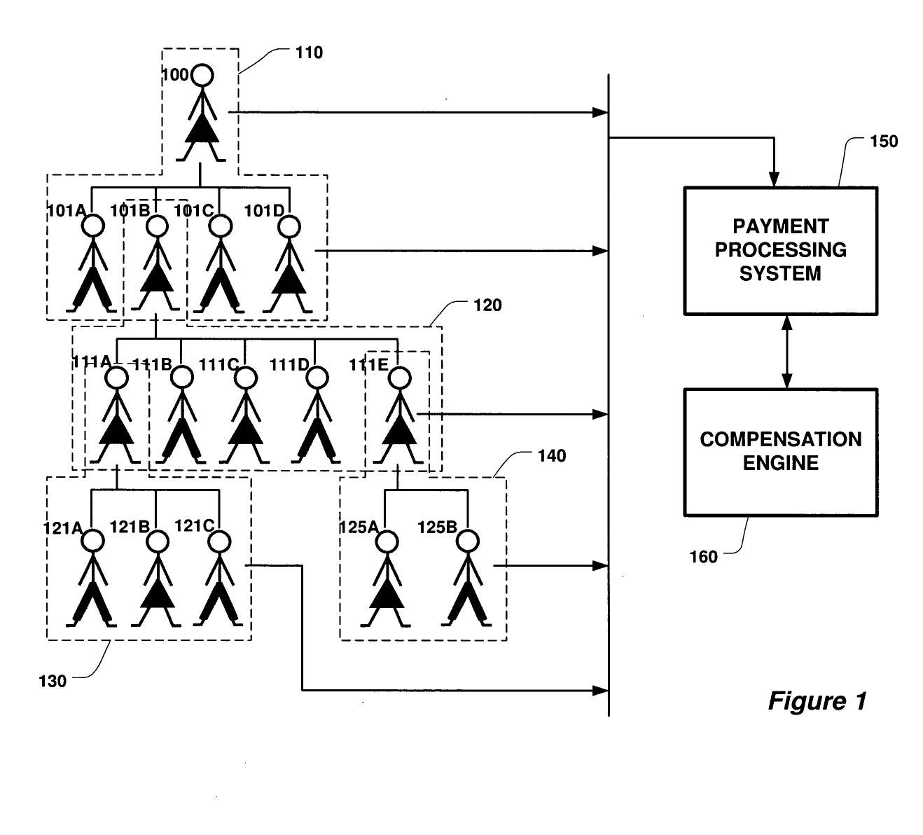

FIG. 1 is an illustration depicting a hierarchical structure of a group of clients as they interact with a payment processing system operated by a payment service provider in accordance with an embodiment of the invention.

In the example of FIG. 1, client 100 is the first of the clients depicted in FIG. 1 to become a client of payment processing system 150, for example by opening a payment card account with the payment service provider that operates payment processing system 150. Clients 101A, 101B, 101C and 101D are clients that have been recruited or referred to payment processing system 150 by client 100 and that have been identified to payment processing system as such. For example, clients 101A, 101B, 101C and 101D may have indicated on their account applications to payment processing system 150 that they were referred by client 100, or client 100 may have informed payment processing system 150 of the identities of prospective clients that client 100 has recruited or to whom client 100 has promoted payment processing system 150. Client 100 and clients 101A, 101B, 101C and 101D (which may be referred to as “subclients” of client 100) may be considered a first group of clients, identified as group 110 in FIG. 1.

Each of clients 101A, 101B, 101C and 101D may refer or recruit their own subclients in the same manner as they were recruited as subclients by client 100. In the example of FIG. 1, client 101B has recruited clients 111A, 111B, 111C, 111D and 111E. The group consisting of client 101B and its subclients (clients 111A, 111B, 111C, 111D and 111E) is identified in FIG. 1 as group 120. Two additional groups 130 and 140 are illustrated in FIG. 1. Group 130 consists of client 111A and clients 121A, 121B and 121C that were recruited or referred by client 111A. Group 140 consists of client 111E and clients 125A and 125B. Payment processing system 150 stores identity information for each client, including identifying data for the client itself as well as data identifying, if applicable, the client that referred or recruited that client.

In one or more embodiments of the invention, a client is instantly or periodically (e.g. daily, weekly, bi-weekly, monthly) awarded incentives based upon the client's own usage of payment processing system 150 and upon the usage by that client's subclients. In one or more embodiments, the amount of incentives a client receives is the sum of a first proportion or percentage of the client's own usage and a second proportion or percentage of usage by the client's subclients. In one or more embodiments, a client may also receive additional incentives based on usage by a subclient's subclients. In one or more embodiments, the incentives are paid by the payment service provider out of the transaction fees received from merchants. In other embodiments, the incentives are paid out of other sources of money as determined by the payment service provider. In one or more embodiments, the percentage amount of incentives paid to clients may vary over time. For example, the total amount of incentives paid to all clients of a service provider may depend on the amount of money in a pool designated by the service provider. For example, the service provider may designate for a particular month that it will pay 90% of the merchant fees it receives from merchants during that month as incentives to clients.

In one example embodiment, a payment service provider receives transaction fees equal to 1.3% of a transaction amount from a merchant for a transaction made by a client. The payment service provider pays 0.48% of a client's own usage, and 0.16% of the client's subclients, to the client as an incentive.

Using the example client structure of FIG. 1, assume the usage of payment services for each of the clients shown in FIG. 1 in an example month are as shown in Table I below:

TABLE 1

| Client | Monthly Usage |
|---|---|
| 100 | $5000 |
| 101A | $2500 |
| 101B | $3000 |
| 101C | $1500 |
| 101D | $5500 |
| 111A | $3500 |
| 111B | $2000 |
| 111C | $4000 |
| 111D | $6000 |
| 111E | $3000 |
| 121A | $1000 |
| 121B | $5500 |
| 121C | $2500 |
| 125A | $4000 |
| 125B | $3500 |

In the current embodiment, each of the clients will receive an incentive equal to 0.48% of their own monthly usage plus 0.16% of the sum of their subclients' monthly usage. According to FIG. 1, four clients, namely clients 100, 101B, 111A and 111E have subclients. Client 100 has subclients 101A, 101B, 101C and 101D. Client 101B has subclients 111A, 111B, 111C, 111D and 111E. Client 111A has subclients 121A, 121B and 121C. And client 111E has subclients 125A and 125B. Table 2 below shows the resulting incentives to each client using the monthly figures of Table 1:

TABLE 2

| | Monthly | Own | Subclient | Subclient | Total |
|---|---|---|---|---|---|
| Client | Usage | Incentive | Usage | Incentive | Incentive |
| 100 | $5,000 | $24.00 | $12,500.00 | $20.00 | $44.00 |
| 101A | $2,500 | $12.00 | | | |
| 101B | $3,000 | $14.40 | $18,500.00 | $29.60 | $44.00 |
| 101C | $1,500 | $7.20 | | | |
| 101D | $5,500 | $26.40 | | | |
| 111A | $3,500 | $16.80 | $9,000.00 | $14.40 | $31.20 |
| 111B | $2,000 | $9.60 | | | |
| 111C | $4,000 | $19.20 | | | |
| 111D | $6,000 | $28.80 | | | |
| 111E | $3,000 | $14.40 | $7,500.00 | $12.00 | $26.40 |
| 121A | $1,000 | $4.80 | | | |
| 121B | $5,500 | $26.40 | | | |
| 121C | $2,500 | $12.00 | | | |
| 125A | $4,000 | $19.20 | | | |
| 125B | $3,500 | $16.80 | | | |

As can be seen by comparing the Total Incentives to Own Incentive dollar amounts in Table 2 for clients 100, 101B, 111A and 111E, the system of the present invention allows a client to significantly increase the client's monthly incentive by referring or recruiting subclients. The client thus benefits by receiving greater incentives, and the payment service provider benefits by having its clients refer and recruit additional clients.

Thus a novel method of generating and distributing financial service fees has been presented. Although the present invention has been described with respect to particular example embodiments, it will be understood by those of skill in the art that the invention is not limited to those particular embodiments, but includes alternative embodiments that will be evident to those skilled in the art. For example, the present invention may be used with smart card on which a client maintains a balance, and the client's incentives may include receiving interest instantaneously or periodically on that balance. Further, use of a payment service of a payment service provider may include use of services of or purchase of goods from providers affiliated with the payment service provider as well as use of services provided by the payment service provider itself (e.g. use of a payment card issued by the payment service provider).

1. A method of providing incentives to clients of a payment service comprising the steps of:
identifying at least one subclient of a first client of the payment service;
providing incentive compensation to said first client based on usage by said first client and said at least one subclient of said first client of said payment service.

2. The method of claim 1 wherein said step of identifying said at least one subclient of said first client comprises being informed of an identity of said subclient by said first client

3. The method of claim 1 wherein said step of identifying said at least one subclient of said first client comprises being informed of an identity of said first client by said subclient.

4. The method of claim 1 wherein said incentive compensation comprises a first amount based on usage by said first client of said payment service and a second amount based on usage by said at least one subclient of said payment service.

5. The method of claim 1 wherein said usage of said payment service comprises using a payment card serviced by said payment service.

6. The method of claim 5 wherein said payment card comprises at least one of the group consisting of a credit card, a debit card, and a smart card.

7. The method of claim 1 wherein said at least one subclient of said first client comprises a first subclient of said first client and a second subclient of said first subclient.

8. The method of claim 7 wherein said incentive compensation provided to said first client comprises compensation based upon use of said payment service by said second subclient.

9. The method of claim 1 wherein use of said payment service comprises use of services provided by an affiliate of said payment service.

10. The method of claim 1 wherein use of said payment service comprises purchase of a good from an affiliate of said payment service.

11. The method of claim 1 wherein said incentive compensation is provided to said first client on a periodic basis.

12. The method of claim 1 wherein said incentive compensation is provided to said first client on a continuous basis.

13. The method of claim 1 wherein said incentive compensation is provided to said first client by crediting said incentive compensation to an account of said first client.

14. The method of claim 11 wherein said incentive compensation is provided to said first client on a daily basis.

15. The method of claim 4 wherein said first amount is determined by multiplying said use by said first client of said payment service by a first factor.

16. The method of claim 15 wherein said second amount is determined by multiplying said use by said at least one subclient of said payment service by a second factor.

17. The method of claim 17 wherein said first factor is greater than said second factor.

18. The method of claim 1 wherein a source of said incentive compensation comprises fees charged by said payment service to merchants for transactions conducted with said merchants by clients using said payment service.

19. The method of claim 15 wherein said first factor is a predetermined amount.

20. The method of claim 15 wherein said first factor varies.
